(19) United States
(12) Patent Application Publication
(10) Pub. No.: US 2006/0065809 A1
(43) Pub. Date: Mar. 30, 2006

(54) Foundation module

(76) Inventor: Tai-Li Chang, Chunan (TW)

Correspondence Address: RABIN & BERDO, P.C., 1101 14 Street, N.W., Suite 500, Washington, DC, 20005, US

(21) Appl. No.: 10/949,242

(22) Filed: Sep. 27, 2004

(51) Int. Cl. E05C 5/00

(52) U.S. Cl. 248/346.05

(57) ABSTRACT

A foundation module is described. The foundation module is utilized in an apparatus, e.g. a projector or the like, that requires a stable working condition. The foundation module includes a base, a wing support, and a linkage. The wing support horizontally extends out of the base to support the apparatus with the operation of the linkage. The wing support can automatically extend from the base to increase the supporting area for the apparatus to work more stable when the apparatus is operating. The wing support can be stored in the base to save the space of the apparatus.

### BACKGROUND OF THE INVENTION

1. Field of Invention

The invention relates to a foundation module and, in particular, to a foundation that can extend out automatically.

2. Related Art

Influenced by the advances in technology and environmental protection, various devices become smaller than before. Take a projector as an example. New small portable models with higher resolutions, brightness, and projection areas have been developed, in comparison with the large standing one years ago. There are also vertical standing models that do not occupy too much planar space than the conventional horizontal ones. Traditionally, most of the horizontal projectors use the three-point support, where one of them can be raised or lowered to adjust the projecting angle of the projector. The other two pods are used to adjust the level of the machine. The vertical models have smaller placing areas, with higher centers of gravity. Therefore, if they also use tripods, the apparatus may become unstable. This may result in damages due to stumbling.

### SUMMARY OF THE INVENTION

To solve the above-mentioned problem, an objective of the invention is to provide a foundation module to increase the stability of apparatuses such as projectors.

The disclosed foundation module includes a base, a wing support, and a linkage. The base is pivotally installed on one side of an apparatus, such as a projector, and rotates about the pivotal point to adjust the projecting angle between the apparatus and the base plane. The wing support is installed on the inner side of the base and can horizontally extend out. The linkage is at the center of the base. The wing support can automatically extend out of the base to support the apparatus with the operation of the linkage. Therefore, when using the apparatus, the wing support is extended out automatically or manually to effectively increase the base area for the apparatus to work more stable. The wing support can be stored in the base to save the space of the apparatus.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a three-dimensional exploded view of the foundation module;

FIG. 2 is a three-dimensional view of the disclosed foundation module with the wing accommodated within;

FIG. 3 is a three-dimensional view of the disclosed foundation module with the wing extended out;

FIG. 4A is a first schematic action diagram of operating the release button a according to an embodiment of the invention;

FIG. 4B is a second schematic action diagram of operating the release button a of the foundation module in FIG. 4A;

FIG. 5A is a first schematic action diagram of operating the release button b according to another embodiment of the invention;

FIG. 5B is a second schematic action diagram of operating the release button b of the foundation module in FIG. 5A; and

FIG. 6 shows an application of the disclosed foundation module on a vertical projector, with the wing extended out.

### DETAILED DESCRIPTION OF THE PREFERRED EMBODIMENT

The present invention will be apparent from the following detailed description, which proceeds with reference to the accompanying drawings, wherein the same references relate to the same elements.

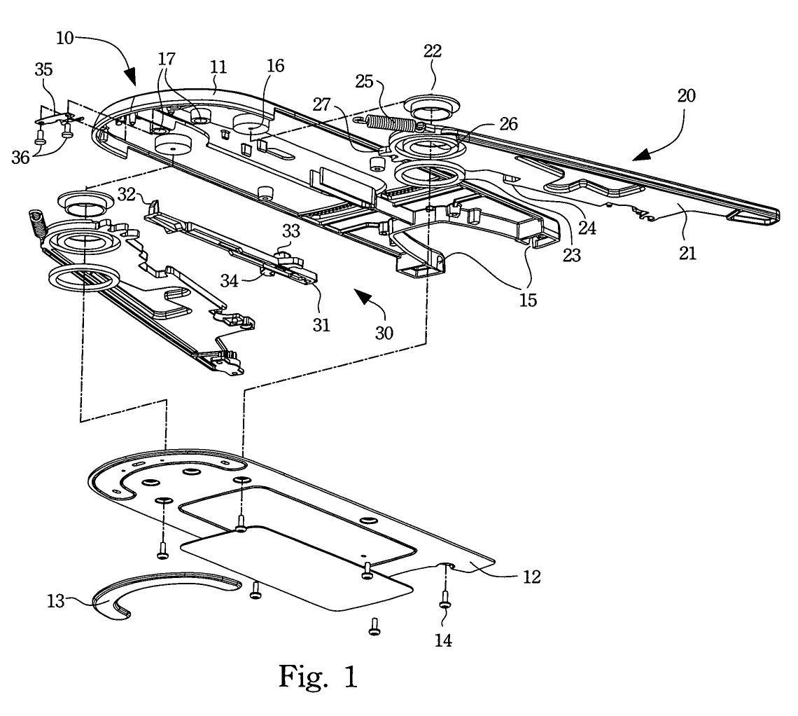

As shown in FIGS. 1, 2, and 3, the disclosed foundation module includes a base 10, a set of wing support 20 inside the base 10 and extensible horizontally along the side of the base 10, and a linkage 30 at the center of the base 10.

The base 10 has a part with similar area and shape to the apparatus 40, such as a projector. The base 10 further contains a base top cover 11, a base bottom cover 12, a wing axis 16, and an apparatus mounting hole 15. The base top cover 11 and the base bottom cover 12 can be fixed. Once they are fixed, the space formed therein can accommodate the wing support 20 and the linkage 30. The bottom surface of the base bottom cover 12 contains at least a stop pad 13 to increase the stability. The apparatus mounting hole 15 is located on one side of the base 10 to pivotally install the apparatus 40 on the base 10. The apparatus 40 such as a projector rotates about the apparatus mounting hole 15 to adjust the projecting angle of the apparatus 40. The wing axis 16 is on the inner side of the base top cover 11 and the base bottom cover 12, opposite to the apparatus mounting hole 15. The base 10 also has a stop button a 17.

The set of wing support contains two wing supports, symmetrically installed on the left and right sides of the base 10. Each of the wing supports 20 contains: a wing 21, a wing hook 24, and an axis mounting hole 26. The axis mounting hole 26 is located on one side of the wing support 20 to mount the wing support 20 on the win axis 16. The wing 21 is thus able to rotate about the wing axis 16. The wing hook 24 is on the inner side of the wing 21. It is connected to a linking hook 34 on the linkage 30. The wing support 20 further contains: an upper pad 22 and a lower pad 23, located on the upper and lower sides of the axis mounting hole 26, respectively. The wing 21 can readily rotate and remain stable without wiggling. The wing support 20 also contains a spring 25 between the wing support 20 and the base 10. The spring 25 provides an elastic force for the wing to rotate about the wing axis 16. The wing 21 thus extends out of the base 10. The wing support further contains at least a stop button b 27. The stop button b 27 and the stop button a 17 on the base 10 restrict the rotation range of the wing 21.

The linkage 30 contains a linking rod 31, a release button a 32, a linking hook 34, and a release button b 33. The release button a 32 is on one end of the linking rod 31, protruding from the surface of the base top cover 11. It moves back and forth horizontally so that the linkage 30 slides back and forth accordingly. The linking hook 34 is on the two sides of the other end of the linking rod 31. The linking hook 34 and a wing hook 24 of the wing support 20 connect to each other. The release button b 33 is installed in the same direction as the release button a 32, located in the vicinity of the linking hook 34 of the linking rod 31. The release button b 33 moves up and down, protruding from or sinking into the surface of the base top cover 11. The part of the linkage 30 closer to the release button b 33 slides up and down accordingly. The linkage 30 further contains a spring chip 35 fixed inside the base 10 to provide an elastic force for the linkage 30. It leans against the top and back of the linkage 30.

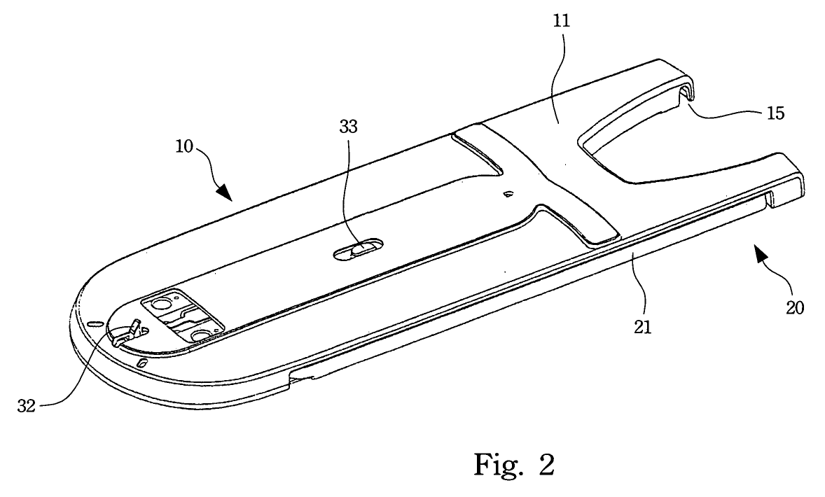

As shown in FIG. 2, when the wing 21 does not extend out, the linkage 30 is pressed toward the wing hook 24 due to the action of the spring chip 35, connecting the linking hook 34 and the wing hook 24. The wing 21 is accommodated and hidden in the base 10. The release button a 32 is also pressed backward. In this case, the release button b 33 sinks under the surface of the base top cover 11, connecting the linking hook 34 and the wing hook 24.

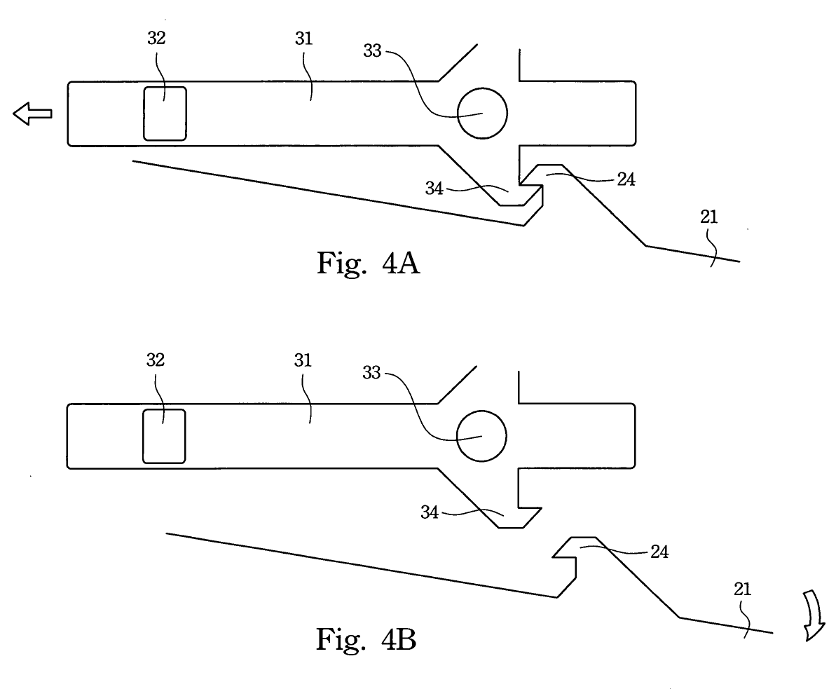

As shown in FIG. 4A, one can manually operate the release button a 32 when releasing to extend the wing 21 for increasing the stability. The release button a 32 is led forward. The linking rod 31 slides forward; the linking hook 34 slides along too. In this case, the spring chip 35 exerts a stress. The spring chip 35 deforms to store this stress. When the linking hook 34 slides to unlink with the wing hook 24, the wing 21 rotates about the wing axis 16 due to the action of the spring 25, extending the wing 21 out of the base 10. When the stop button a 17 and the stop button b 27 touch each other, the wing 21 stops rotating. When releasing the release button a 32 in operation, the spring chip 35 releases the previously stored stress energy to push the linking rod 31 back to its original position. The release button a 32 also returns to its original position. As shown in FIG. 4b, this finishes the extension of the wing 21. The horizontal extension of the wing 21 on both sides of the base 10 enlarges the bottom supporting area of the foundation module. To accommodate the wing 21 in the base 10, one simply uses the wing 21 to impose a force on the base 10, forcing the linkage between the linking hook 34 and the wing hook 24.

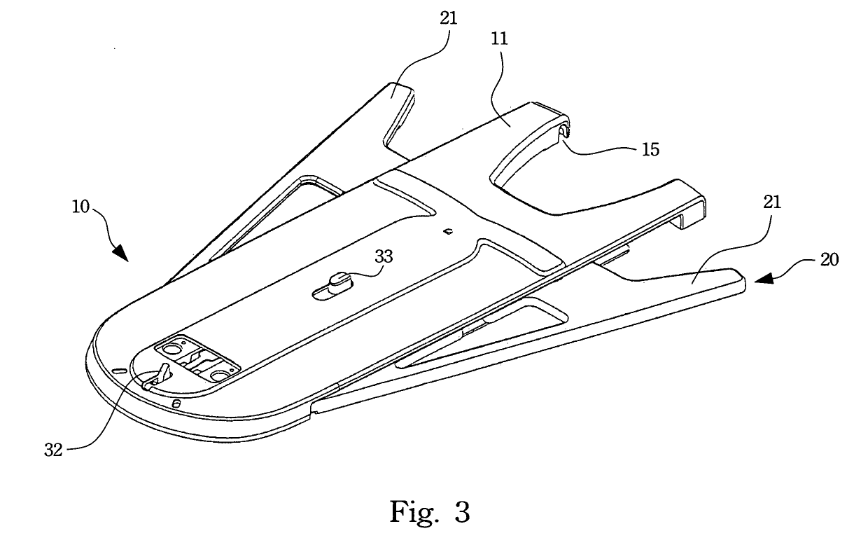

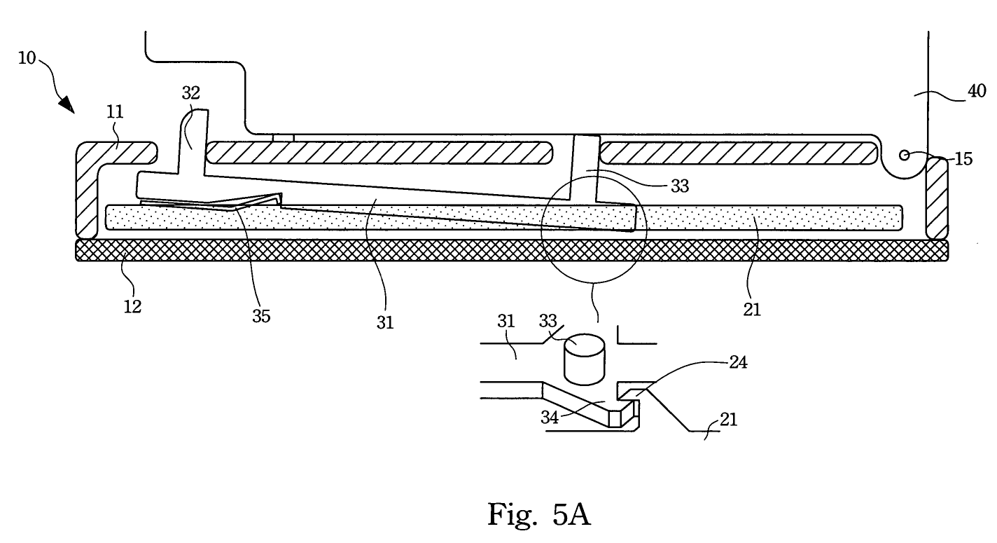

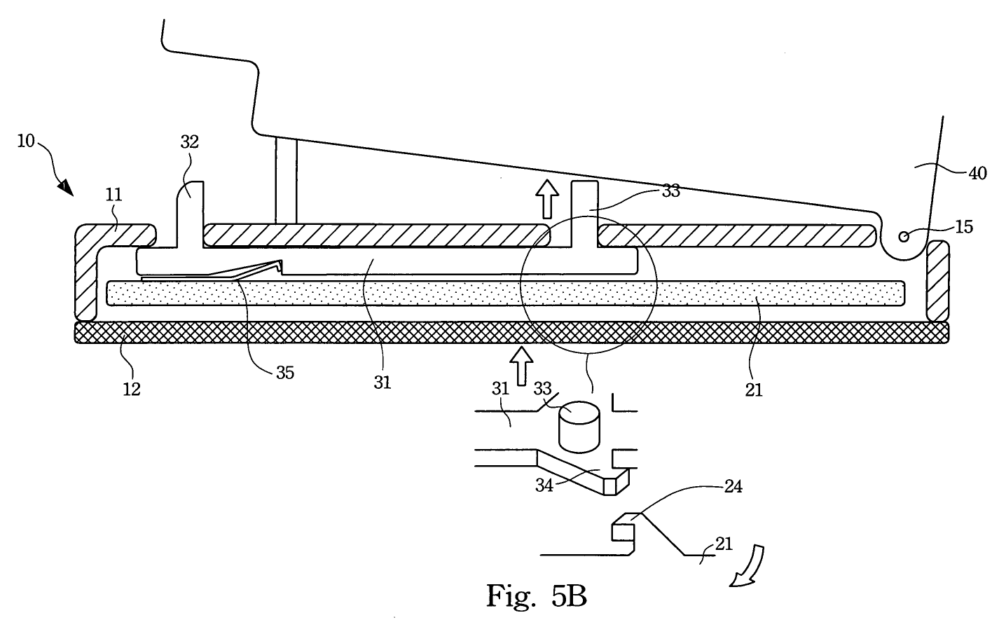

The disclosed foundation module can further automatically release the wing 21 for it to extend through the action of the release button b 33. With reference to FIGS. 2 and 5A, when there is no projecting angle between the apparatus 40 such as a projector and the base 10, the release button b 33 is depressed by the apparatus 40 to sink under the surface of the base top cover 11. Due to the depression of the release button b 33, the part of the linkage 30 in the vicinity of the release button b 33 is also depressed to sink. The linking hook 34 and the wing hook 24 are thus in the link position. Due to the action of the spring chip 35, the linking rod 31 depresses in the direction of the wing hook 24, accommodating the wing 21 in the base 10. When there is a projecting angle between the apparatus 40 and the base 10, as shown in FIG. 3 and 5B, the bottom surface of the apparatus 40 departs from the base top cover 11, unable to depressing the release button b 33. The release button b 33 thus protrudes from the surface of the base top cover 11 due to the action of the spring chip 35. The linking hook 34 floats up at the same time. At this time, the linking hook 34 and the wing hook 24 are on different planes and unable to connect to each other. The link is thus released, as in FIG. 5B. Because of the spring 25, the wing 21 starts to rotate about the wing axis 16, extending the wing out of the base 10. Once the stop button a 17 and the stop button b 27 touch each other, the wing 21 stops rotating. This completes the extension of the wing 21.

To accommodate the extended wing 21 in the base 10, one has to adjust the projecting angle between the apparatus 40 and the base 10 back to zero if the release button b 33 protrudes from the surface of the base top cover 11. The apparatus 40 is made to depress the release button b 33 to make it sink under the surface of the base top cover 11 before the linking hook 34 and the wing hook 24 can link with each other. When the release button b 33 is pressed down, the linking rod 31 is also depressed to impose a stress on the spring chip 35. The spring chip 35 deforms and stores the stress for the required spring force to push the release button b 33 out next time. The wing is then pushed to rotate about the wing axis 16 toward the base 10, imposing a stress on the spring 25. The spring 25 deforms to store the stress for the required spring force to extend the wing 21 next time. Once the wing hook 24 touches the slant surface of the linking hook 34, the linking hook 34 slides along the surface. The linking rod 31 is pushed to impose a stress on the spring chip 35, which deforms to store the stress. When the wing hook 24 enters the opening of the linking hook 34, the spring chip 35 first releases the stored stress in the form of a spring force. The linking rod 31 is pressed backward, linking the linking hook 34 and the wing hook 24. This completes the accommodation of the wing 21.

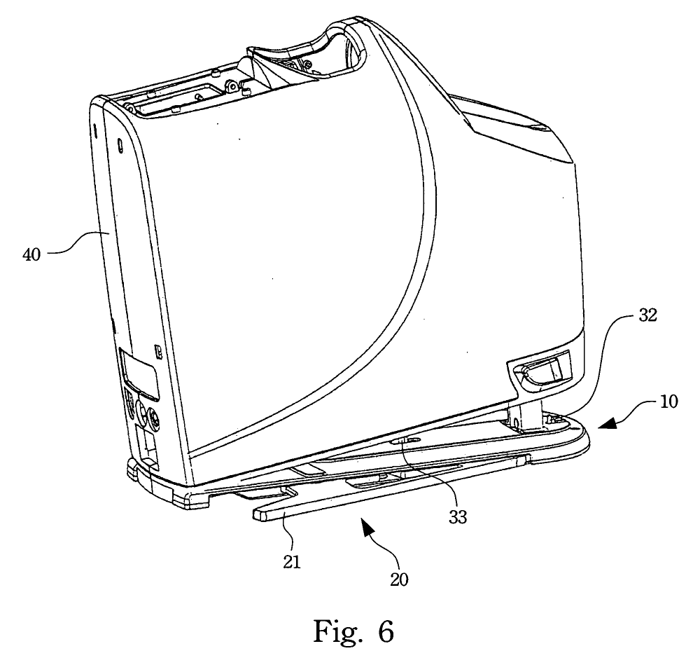

In FIG. 6, we show that the extensible wing of the invention can increase the stability by enlarging the base area. Moreover, it does not occupy extra space when contained in the base. Therefore, the invention can have a wide variety of applications.

Within the scope of the invention, there may be various kinds of modifications. For example, in the method of using the release button a 32 to release the wing 21, the release button a 32 can be connected with the projecting angle adjusting mechanism o the apparatus 40. When the projecting angle of the apparatus is changed, the release button a 32 is brought to move back and forth, automatically extending the wing 21 out to increase its stability. One may also install a damping mechanism in the disclosed foundation module so that the wing 21 does not jump out of the base 10 all of a sudden, but extends out in a slow and smooth way. The shapes and positions of the components in the invention are not limited to those shown in the drawings. As long as the required functions can be achieved, bases 10, wings 20, and linkages 30 of all kinds of shapes and installation positions can be used. Such variations should be construed as part of the invention.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A foundation module comprising:
a base; and
a wing support, installed in the base and extensible horizontally toward both sides of the base to enlarge the bottom supporting area of the foundation module.

2. The foundation module of claim 1, wherein the wing support includes:
a wing, being in the base and extensible horizontally;
a wing hook, disposed on the inner side of the wing; and
an axis mounting hole, formed on one end of the wing support to mount the wing on the base for the wing to rotate about the axis mounting hole, thereby extending out of the base horizontally.

3. The foundation module of claim 2, wherein the wing support further includes:
a spring, installed between the base and the wing support to provide an elastic force so that the wing support extends out horizontally due to the action of the spring.

4. The foundation module of claim 2, wherein the wing support further includes:
an upper pad; and
a lower pad;
wherein the upper pad and the lower pad are provided on the upper and lower sides of the axis mounting hole, respectively, so that the wing stably rotates without wiggling.

5. The foundation module of claim 2, wherein the wing support further includes a stop button b to restrict the rotation range thereof.

6. The foundation module of claim 2 further comprising a linkage provided at the center of the base and coupled with the wing support.

7. The foundation module of claim 6, wherein the linkage includes:
a linking rod, provided at the center of the base;
a linking hook, formed on one side of the linking rod and connects with the wing hook.

8. The foundation module of claim 7, wherein the linkage further includes a release button a on the linking rod, the release button a protrudes from a surface of the base and moves back and forth horizontally, the linkage moves back and forth due to the operation of the release button a, and the linking hook departs from the wing hook when the release button a moves forward, releasing the connection.

9. The foundation module of claim 8, wherein the release button a is connected with a projecting angle adjusting mechanism of an electronic device for the release button a to move back and forth.

10. The foundation module of claim 7, wherein the linkage further includes a release button b on the linking rod in the vicinity of the linking hook, the release button b moves up and down to protrude from and sink into the surface of the base so that the part of the linkage in the vicinity of the release button b moves up and down due to the operation of the release button b, and the linking hook and the wing hook depart from each other when the release button b moves upward.

11. The foundation module of claim 6, wherein the linkage further includes a spring chip located inside the base to provide the linkage an elastic force, pressing against the top and back of the linkage.

12. The foundation module of claim 1, wherein the base includes:
a base top cover;
a base bottom cover, connected to the base top cover to form a space for accommodating the wing support;
a wing axis, disposed between the base top cover and the base bottom cover to couple with the wing support; and
an apparatus mounting hole, formed on one side of the base to mount an apparatus on the base for the apparatus to rotate about the apparatus mounting hole, thereby adjusting the projecting angle between the apparatus and the base.

13. The foundation module of claim 12, wherein the bottom of the base bottom cover contains at least a stop pad to increase its stability.

14. The foundation module of claim 12, wherein the base includes at least a stop button a to restrict the rotation range of the wing support.

15. The foundation module of claim 1 further comprising a damping mechanism so that the wing support extends out in a slow and smooth way instead of jumping out of the base suddenly.

16. The foundation module of claim 1, wherein the area and shape of the base are similar to those of the apparatus bottom.
